(19) United States
(12) Patent Application Publication
(10) Pub. No.: US 2010/0088441 A1
(43) Pub. Date: Apr. 8, 2010

(54) MULTI-PROCESSOR CONTROLLER FOR AN INVERTER IN AN ELECTRIC TRACTION SYSTEM FOR A VEHICLE

(75) Inventors: TED D. PETERSON, PLAYA DEL REY, CA (US); YAJING DUAN, TORRANCE, CA (US); RAY M. RANSOM, BIG BEAR CITY, CA (US); MARK L. SELOGIE, MANHATTAN BEACH, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/247,773

(22) Filed: Oct. 8, 2008

(51) Int. Cl. G06F 13/40

(52) U.S. Cl. 710/110

(57) ABSTRACT

A multi-processor controller is provided. The multi-processor controller can be used to control the operation of an inverter in a vehicle-based electric traction system. The multi-processor controller includes a master processor device having three serial peripheral interfaces (SPIs), and three slave processor devices coupled to the master processor device via the SPIs. The master processor device issues commands to the slave processor devices to control operation of the inverter.

### TECHNICAL FIELD

Embodiments of the subject matter described herein relate generally to electric drive systems for vehicles. More particularly, embodiments of the subject matter relate to control processors utilized for an electrical inverter drive system.

### BACKGROUND

In recent years, advances in technology, as well as ever evolving tastes in style, have led to substantial changes in the design of automobiles. One of the changes involves the power usage and complexity of the various electrical systems within automobiles, particularly alternative fuel vehicles, such as hybrid, electric, and fuel cell vehicles.

Many of the electrical components, including the electric motors used in such vehicles, receive electrical power from alternating current (AC) power supplies. However, the power sources (e.g., batteries) used in such applications provide direct current (DC) power. Thus, devices known as “power inverters” are used to convert the DC power into AC power. Such power inverters often utilize several switches, or transistors, operated at various intervals to convert the DC power to AC power.

Typically, the switches of the inverter are operated by using pulse-width modulation (PWM) techniques to control the amount of current and/or voltage provided to the electric motor. Often, a microprocessor architecture or control module generates PWM signals for the switches in the inverter, and provides the PWM signals to a gate driver, which turns the switches on and off. Some inverter controller modules utilize multiple processor chips mounted on a circuit board. Traditional multi-processor controller deployments for vehicle-based inverter systems utilize parallel buses to accommodate inter-processor data communication. Such parallel bus architectures, however, typically require additional processing overhead and/or interface hardware designed to support parallel data transfer. This additional processing overhead and interface hardware increases the cost, size, and complexity of the inverter controller module.

### BRIEF SUMMARY

A multi-processor controller is provided for an inverter of an electric drive system in a vehicle. The controller utilizes serial inter-processor data communication between a plurality of cooperating processor devices. The use of serial data communication interfaces eliminates the need for wide parallel address lines. This reduces the amount of inter-processor signal lines, and the resulting architecture is more robust than traditional parallel bus architectures. Moreover, the multi-processor controller provided here reduces timing issues and errors that can be prevalent in a parallel bus architecture. From an implementation standpoint, the multi-processor controller provided here employs a smaller circuit board (which is desirable from a packaging perspective), has a reduced parts count relative to an equivalent parallel bus architecture (which improves reliability and robustness), and can be manufactured at lower cost.

An embodiment of a multi-processor controller for an inverter in a vehicle-based electric traction system is provided. The multi-processor controller includes a master processor device comprising a first serial peripheral interface (SPI), and comprising a second SPI, a first slave processor device coupled to the master processor device, the first slave processor device comprising a fourth SPI coupled to the first SPI, and comprising a fifth SPI coupled to the second SPI, and a second slave processor device coupled to the master processor device, the second slave processor device comprising a seventh SPI coupled to the first SPI, and comprising an eighth SPI coupled to the second SPI. The master processor device issues commands to the first slave processor device and the second slave processor device to control operation of the inverter.

An embodiment of a multi-processor controller is also provided. The controller includes: a master processor device having a first SPI for inter-processor data communication, a second SPI for inter-processor data communication, and a third SPI for inter-processor data communication; a first slave processor device having a fourth SPI for inter-processor data communication, a fifth SPI for inter-processor data communication, and a sixth SPI for inter-processor data communication; a second slave processor device having a seventh SPI for inter-processor data communication, an eighth SPI for inter-processor data communication, and a ninth SPI for inter-processor data communication; and a third slave processor device having a tenth SPI for inter-processor data communication, an eleventh SPI for inter-processor data communication, and a twelfth SPI for inter-processor data communication. The first SPI is coupled to the fourth SPI, the seventh SPI, and the tenth SPI. The second SPI is coupled to the fifth SPI, the eighth SPI, and the eleventh SPI. The third SPI is coupled to the twelfth SPI, and the sixth SPI is coupled to the ninth SPI.

Also provided is an embodiment of an electric drive system for a vehicle. The electric drive system includes an energy source, an electric motor, an inverter coupled between the energy source and the electric motor, and a multi-processor controller coupled to the inverter. The inverter is configured to convert direct current from the energy source into alternating current for the electric motor. The multi-processor controller includes a master processor device having a plurality of SPIs for inter-processor data communication, and a plurality of slave processor devices coupled to the master processor device via the plurality of SPIs. The plurality of slave processor devices are configured to control operation of the inverter, under the command of the master processor device, to achieve a desired power flow between the energy source and the electric motor.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of an electric drive system suitable for use in a vehicle; and

FIG. 2 is a schematic representation of an embodiment of a multi-processor controller suitable for use with an inverter of a vehicle-based electric traction system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

In addition, certain terminology may be used in the following description for the purpose of reference only, and such use is not intended to be limiting. For example, the terms “first,” “second,” and similar numerical terms referring to elements, structures, or components do not imply a sequence, order, preference, or priority, unless clearly indicated by the context. Such terminology may include the words specifically mentioned above, derivatives thereof, and words of similar import.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

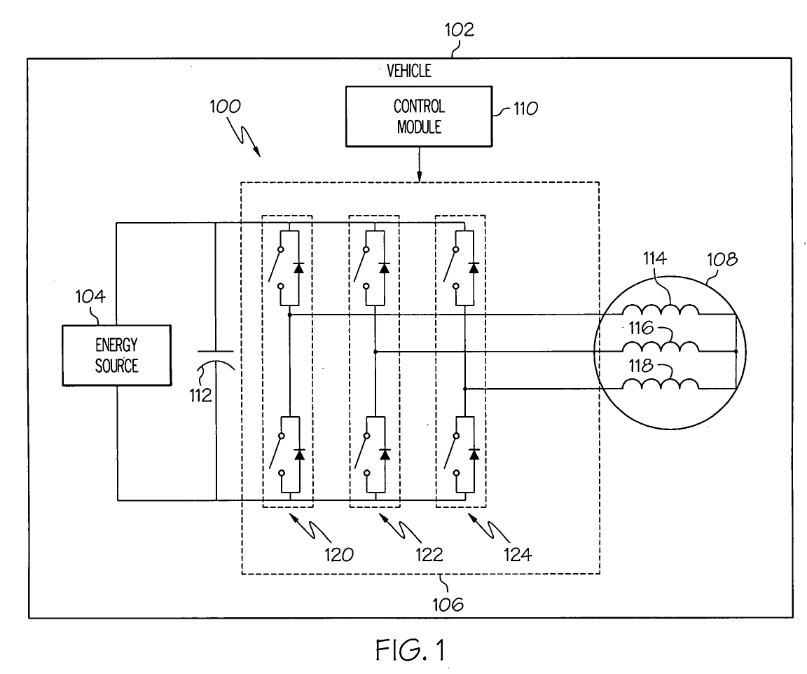

FIG. 1 is a schematic representation of an embodiment of an electric drive system 100 suitable for use in a vehicle 102. The vehicle 102 is preferably realized as an automobile, such as, for example, a sedan, a wagon, a truck, or a sport utility vehicle, and vehicle 102 may be a two wheel drive vehicle (e.g., rear wheel drive or front wheel drive), a four wheel drive vehicle, or an all wheel drive vehicle. The vehicle 102 may also incorporate any one of, or combination of, a number of different types of engines, such as, for example, a gasoline or diesel fueled combustion engine, a “flex fuel vehicle” engine (e.g., an engine that uses a mixture of gasoline and alcohol for fuel), a gaseous compound (e.g., hydrogen and natural gas) fueled engine, a combustion/electric motor hybrid engine, and an electric motor.

In an exemplary embodiment, electric drive system 100 includes, without limitation: an energy source 104, a power inverter module 106, a motor 108, and a control module 110. A capacitor 112 may be coupled between energy source 104 and power inverter module 106 such that capacitor 112 and energy source 104 are electrically parallel. In this regard, capacitor 112 may alternatively be referred to as a direct current (DC) link capacitor or bulk capacitor. In an exemplary embodiment, control module 110 operates power inverter module 106 to achieve a desired power flow between energy source 104. For the sake of brevity, conventional techniques related to vehicle-based electric traction/drive systems, power inverters, inverter controllers, and other functional aspects of the systems (and the individual operating components of the systems) may not be described in detail herein.

Energy source 104 may comprise a battery, a battery pack, a fuel cell, a fuel cell stack, an ultracapacitor, a controlled generator output, or another suitable DC voltage source. A battery may be any type of battery suitable for use in a desired application, such as a lead acid battery, a lithium-ion battery, a nickel-metal battery, or another rechargeable battery.

In an exemplary embodiment, motor 108 is realized as an electric motor. As shown in FIG. 1, motor 108 can be realized as a multi-phase alternating current (AC) motor that includes a set of windings (or coils), wherein each winding corresponds to a phase of motor 108. Although not illustrated, motor 108 includes a stator assembly (including the windings), a rotor assembly (including a ferromagnetic core), and a cooling fluid (i.e., coolant), as will be appreciated by one skilled in the art. Motor 108 may be an induction motor, a permanent magnet motor, or any type suitable for the desired application. Although not illustrated, motor 108 may also include a transmission integrated therein such that motor 108 and the transmission are mechanically coupled to at least some of the wheels of vehicle 102 through one or more drive shafts.

In the exemplary embodiment shown in FIG. 1, motor 108 is realized as a three-phase AC motor having a three-phase set of windings including a first winding 114 (for phase A), a second winding 116 (for phase B), and a third winding 118 (for phase C). It should be understood that the labeling of phases A, B, and C is for ease of description and is not intended to limit the subject matter in any way. Furthermore, it should be understood that although electric drive system 100 is described herein in the context of a three-phase motor, the subject matter described herein is independent of the number of phases of the motor.

In the exemplary embodiment shown in FIG. 1, power inverter module 106 includes six switches (which may be realized with semiconductor devices, such as transistors and/or switches) with antiparallel diodes (i.e., diodes which are antiparallel to each switch). Preferably, the switches are realized using insulated-gate bipolar transistors (IGBTs). As shown, the switches in power inverter module 106 are arranged into three phase legs (or pairs), with phase legs 120, 122, 124 each being coupled to a respective end of the windings 114, 116, 118. In this regard, phase leg 120 is coupled to first winding 114, phase leg 122 is coupled to second winding 116, and phase leg 124 is coupled to third winding 118. Thus, phase leg 120 may be referred to as the phase A leg, phase leg 122 the phase B leg, and phase leg 124 the phase C leg. When controlled in an appropriate manner, power inverter module operates to convert DC from energy source 104 into AC for motor 108.

In an exemplary embodiment, control module 110 is in operable communication and/or electrically coupled to power inverter module 106. Control module 110 is responsive to commands received from the driver of vehicle 102 (e.g., via an accelerator pedal) and provides commands to power inverter module 106 to control the output of the inverter phase legs 120, 122, 124. In an exemplary embodiment, control module 110 is configured to modulate and control power inverter module 106 using high frequency pulse width modulation (PWM). Control module 110 provides PWM signals to operate the switches within the inverter phase legs 120, 122, 124 to cause output voltages to be applied across windings 114, 116, 118 within motor 108 in order to operate motor 108 with a commanded torque. Although not illustrated, control module 110 may generate current and/or voltage commands for the phases of motor 108 in response to receiving a torque command from an electronic control unit (ECU), system controller, or another control module within vehicle 102. Further, in some embodiments, control module 110 may be integral with an ECU or another vehicle control module.

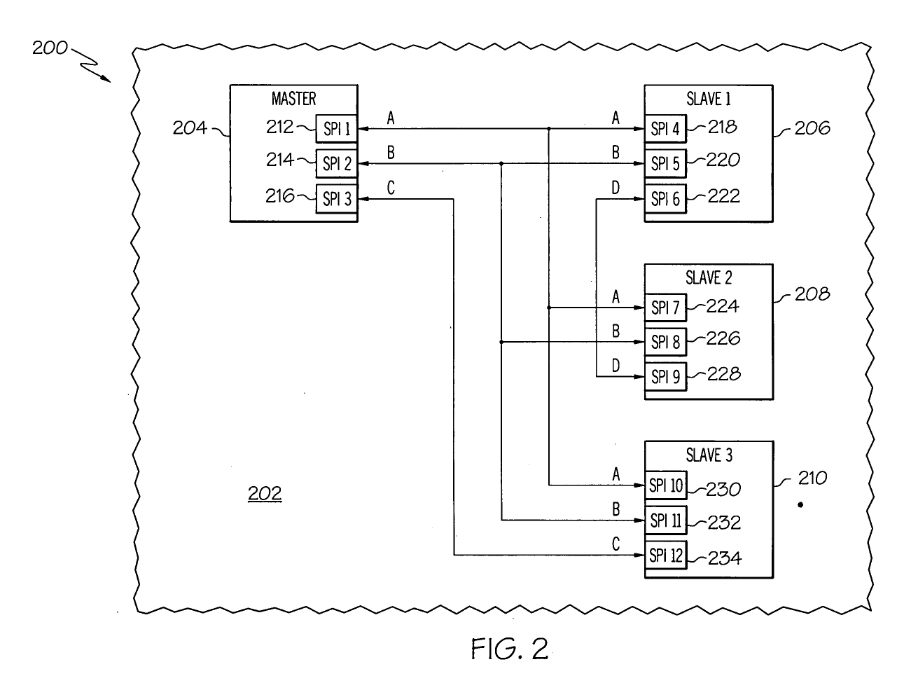

In practice, control module 110 may include, cooperate with, or be realized as a multi-processor controller. In this regard, FIG. 2 is a schematic representation of an embodiment of a multi-processor controller 200 suitable for use with an inverter (such as power inverter module 106) of a vehicle-based electric traction system. For simplicity and for ease of illustration, the output terminals of the processor devices are not shown in FIG. 2 (in practice, the outputs of the processor devices will be routed as needed for control of the inverter). Multi-processor controller 200 may be described herein in terms of functional and/or logical block components, and with reference to symbolic representations of operations, processing tasks, and functions that may be performed by various computing components or devices. It should be appreciated that the various block components shown in FIG. 2 may be realized by any number of hardware, software, and/or firmware components configured to perform the specified functions.

Multi-processor controller 200 includes a plurality of processor devices coupled together in a manner that accommodates inter-processor data communication between the various processor devices. Although the actual number of processor devices may differ from one embodiment to another, the illustrated embodiment includes four physically distinct and separate processor devices, each implemented as a distinct integrated circuit chip or package. The preferred embodiment of multi-processor controller 200 is arranged in a master-slave architecture, where one of the four processor devices serves as the master device, and the remaining three processor devices serve as slave devices. For this particular embodiment, all of the individual processor devices are mounted on a single physical circuit board 202 (a section of which is depicted in FIG. 2). In other words, even though the processor devices are realized as physically distinct packages, they are all mounted to one common board or substrate. Circuit board 202 may include a number of conductive traces or lines integrally formed thereon; these conductive elements facilitate the transfer of signals, data, and commands between the processor devices.

The illustrated embodiment of multi-processor controller 200 includes a master processor device 204, a first slave processor device 206, a second slave processor device 208, and a third slave processor device 210. In practice, multi-processor controller 200 may utilize more than one master processor device, and any number of slave processor devices. As mentioned above, the processor devices are suitably configured and programmed to control the operation of an inverter in a vehicle-based electric traction system. In this regard, master processor device 204 can be suitably configured to issue commands to slave processor devices 206, 208, 210 to control the operation of the inverter as desired. More specifically, slave processor devices 206, 208, 210 are suitably configured to control the operation of the inverter, under the command and control of master processor device 204, to achieve the desired power flow between the energy source (e.g., energy source 104) and the electric motor (e.g., motor 108).

Each processor device shown in FIG. 2 may be implemented or realized as an integrated circuit component that is designed to perform the functions described here. In addition, each processor device is suitably configured to support inter-processor data communication using a serial data transfer protocol. The processing core of each processor device may be similar or identical and all of the processor devices may be realized using the same physical device and packaging. In preferred embodiments, slave processor devices 206, 208, 210 are identical components, while master processor device 204 is realized as a different component (to accommodate the enhanced functionality of master processor device 204, relative to the slave processor devices).

Although multi-processor controller 200 can employ any suitable serial data transmission technique, protocol, or interface, the embodiment described here utilizes serial peripheral interfaces (SPIs) to accommodate inter-processor data communication. Each SPI can be implemented as a four-wire serial bus that accommodates four signals: a clock signal; a chip select signal; a serial data input signal; and a serial data output signal. The SPIs allow the processor devices to communicate independently with each other or in some synchronous manner if desired. The SPI functionality and logic represents an integrated and “self contained” feature of the host processor device. In other words, no additional hardware or processing overhead is needed to implement the SPI function of a processor device.

In accordance with one embodiment, each processor device in multi-processor controller 200 is a 32-bit processor that employs 32-bit words, and each SPI can accommodate the bidirectional transfer of serial words having a word length of up to 16 bits. When an SPI is used for inter-processor data communication, the receiving device or chip is selected and the serial data line is used to transfer the data in a serial manner. The design and operation of SPIs will not be described in detail here because they are well known and understood by those familiar with data transfer interface technology.

Referring to FIG. 2, master processor device 204 includes at least three SPIs: a first SPI 212; a second SPI 214; and a third SPI 216 (arbitrarily labeled SPI 1, SPI 2, and SPI 3). Likewise, first slave processor device 206 includes at least a fourth SPI 218, a fifth SPI 220, and a sixth SPI 222 (arbitrarily labeled SPI 4, SPI 5, and SPI 6), second slave processor device 208 includes at least a seventh SPI 224, an eighth SPI 226, and a ninth SPI 228 (arbitrarily labeled SPI 7, SPI 8, and SPI 9), and third slave processor device 210 includes at least a tenth SPI 230, an eleventh SPI 232, and a twelfth SPI 234 (arbitrarily labeled SPI 10, SPI 11, and SPI 12). In alternate embodiments, the number of SPIs supported by any of the processor devices may be more or less than three.

Master processor device 204 and slave processor devices 206, 208, 210 are coupled to each other via the various SPIs. As depicted in FIG. 2, first SPI 212 is coupled to fourth SPI 218, to seventh SPI 224, and to tenth SPI 230. This accommodates inter-processor data communication between master processor device 204 and each of the slave processor devices 206, 208, 210 using a SPI “channel” (labeled A in FIG. 2). Similarly, second SPI 214 is coupled to fifth SPI 220, to eighth SPI 226, and to eleventh SPI 232. This arrangement accommodates inter-processor data communication between master processor device 204 and each of the slave processor devices 206, 208, 210 using a different SPI channel (labeled B in FIG. 2). Third SPI 216 is coupled to twelfth SPI 234, creating another SPI channel (labeled C in FIG. 2). Moreover, sixth SPI 222 is coupled to ninth SPI 228, creating yet another SPI channel (labeled D in FIG. 2).

As depicted in FIG. 2, first SPI 212, fourth SPI 218, seventh SPI 224, and tenth SPI 230 correspond to one another; second SPI 214, fifth SPI 220, eighth SPI 226, and eleventh SPI 232 correspond to one another; third SPI 216 corresponds to twelfth SPI 234; and sixth SPI 222 corresponds to ninth SPI 228. Although FIG. 2 depicts each SPI channel as a single line, a deployment of multi-processor controller 200 can utilize a plurality of conductive lines for each SPI channel. For example, an exemplary embodiment might employ a four-wire bus for each SPI channel (to carry clock, chip select, input data, and output data signals).

In the illustrated embodiment, master processor device 204 issues commands to slave processor devices 206, 208, 210 using SPI channel A and SPI channel B. In this example, first slave processor device 206 and second slave processor device 208 primarily function as the motor controller logic for the inverter, while slave processor device 210 primarily functions as an auxiliary motor controller. It also provides the watchdog function for master processor device 204. Accordingly, SPI channel A can be utilized as the primary means for carrying data traffic between master processor device 204 and slave processor devices 206, 208, 210, and SPI channel B can be utilized as a secondary, backup, or redundant means for carrying data traffic between master processor device 204 and slave processor devices 206, 208, 210.

In this exemplary embodiment, master processor device 204 and third slave processor device 210 support inter-processor monitoring using SPI channel C (i.e., using third SPI 216 and twelfth SPI 234). Similarly, first slave processor device 206 and second slave processor device 208 support inter-processor monitoring of each other using SPI channel D (i.e., using sixth SPI 222 and ninth SPI 228). Such inter-processor monitoring represents a “watchdog” feature where two processor devices monitor or analyze the operation of one another for diagnostic purposes. This watchdog feature is desirable to determine whether the processor devices are working as intended. If a processor device fails, becomes erratic, or is operating in an unintended manner, then the companion processor device can detect the problem and initiate corrective action if necessary. For simplicity, inter-processor monitoring in this manner need not be expanded beyond two individual processor devices, although alternate embodiments may utilize redundant monitoring that involves three or more processor devices.

It should be appreciated that the multi-processor controller architecture and topology described herein can be utilized in applications other than vehicle-based inverters and electric traction systems. The inverter application mentioned above is merely one suitable use, and the subject matter is not limited or restricted to such a use. Multi-processor controller 200 can be realized using less signal lines, reduced signal routing, and less circuit board space than an equivalent controller that utilizes parallel bus interfaces. When operating, multi-processor controller 200 exhibits increased communication robustness, reduced timing problems, and reduced data transmission errors relative to conventional architectures that employ parallel bus interfaces. Moreover, the elimination of control logic and interface hardware allows multi-processor controller 200 to be implemented with less parts, resulting in improved reliability and reduced manufacturing cost.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A multi-processor controller for an inverter in a vehicle-based electric traction system, the multi-processor controller comprising:
a master processor device comprising a first serial peripheral interface (SPI), and comprising a second SPI;
a first slave processor device coupled to the master processor device, the first slave processor device comprising a fourth SPI coupled to the first SPI, and comprising a fifth SPI coupled to the second SPI; and
a second slave processor device coupled to the master processor device, the second slave processor device comprising a seventh SPI coupled to the first SPI, and comprising an eighth SPI coupled to the second SPI; wherein:
the master processor device issues commands to the first slave processor device and the second slave processor device to control operation of the inverter.

2. The multi-processor controller of claim 1, further comprising a third slave processor device coupled to the master processor device, the third slave processor device comprising a tenth SPI coupled to the first SPI, and comprising an eleventh SPI coupled to the second SPI.

3. The multi-processor controller of claim 2, wherein:
the master processor device comprises a third SPI; and
the third slave processor device comprises a twelfth SPI coupled to the third SPI.

4. The multi-processor controller of claim 3, wherein the master processor device and the third slave processor device support inter-processor monitoring using the third SPI and the twelfth SPI.

5. The multi-processor controller of claim 1, wherein:
the second slave processor device comprises a sixth SPI; and
the third slave processor device comprises a ninth SPI coupled to the sixth SPI.

6. The multi-processor controller of claim 5, wherein the first slave processor device and the second slave processor device support inter-processor monitoring using the sixth SPI and the ninth SPI.

7. The multi-processor controller of claim 1, further comprising a single physical circuit board, wherein the master processor device, the first slave processor device, and the second slave processor device are all mounted on the single physical circuit board.

8. A multi-processor controller comprising:
a master processor device having a first serial peripheral interface (SPI) for inter-processor data communication, a second SPI for inter-processor data communication, and a third SPI for inter-processor data communication;
a first slave processor device having a fourth SPI for inter-processor data communication, a fifth SPI for inter-processor data communication, and a sixth SPI for inter-processor data communication;
a second slave processor device having a seventh SPI for inter-processor data communication, an eighth SPI for inter-processor data communication, and a ninth SPI for inter-processor data communication; and
a third slave processor device having a tenth SPI for inter-processor data communication, an eleventh SPI for inter-processor data communication, and a twelfth SPI for inter-processor data communication; wherein
the first SPI is coupled to the fourth SPI, the seventh SPI, and the tenth SPI;
the second SPI is coupled to the fifth SPI, the eighth SPI, and the eleventh SPI;
the third SPI is coupled to the twelfth SPI; and
the sixth SPI is coupled to the ninth SPI.

9. The multi-processor controller of claim 8, wherein the master processor device issues commands to the first slave processor device, the second slave processor device, and the third slave processor device using the first SPI and the second SPI.

10. The multi-processor controller of claim 8, wherein the master processor device and the third slave processor device support inter-processor monitoring using the third SPI and the twelfth SPI.

11. The multi-processor controller of claim 8, wherein the first slave processor device and the second slave processor device support inter-processor monitoring using the sixth SPI and the ninth SPI.

12. The multi-processor controller of claim 8, further comprising a single physical circuit board, wherein the master processor device, the first slave processor device, the second slave processor device, and the third slave processor device are all mounted on the single physical circuit board.

13. An electric drive system for a vehicle, the electric drive system comprising:
an energy source;
an electric motor;
an inverter coupled between the energy source and the electric motor, the inverter being configured to convert direct current from the energy source into alternating current for the electric motor; and
a multi-processor controller coupled to the inverter, the multi-processor controller comprising:
a master processor device having a plurality of serial peripheral interfaces (SPIs) for inter-processor data communication; and
a plurality of slave processor devices coupled to the master processor device via the plurality of SPIs, the plurality of slave processor devices being configured to control operation of the inverter, under the command of the master processor device, to achieve a desired power flow between the energy source and the electric motor.

14. The electric drive system of claim 13, the plurality of slave processor devices comprising:
a first slave processor device coupled to the master processor device via a respective plurality of SPIs;
a second slave processor device coupled to the master processor device via a respective plurality of SPIs; and
a third slave processor device coupled to the master processor device via a respective plurality of SPIs.

15. The electric drive system of claim 14, wherein:
the master processor device comprises a first SPI, a second SPI, and a third SPI;
the first slave processor device comprises a fourth SPI corresponding to the first SPI, a fifth SPI corresponding to the second SPI, and a sixth SPI;
the second slave processor device comprises a seventh SPI corresponding to the first SPI, an eighth SPI corresponding to the second SPI, and a ninth SPI corresponding to the sixth SPI; and
the third slave processor device comprises a tenth SPI corresponding to the first SPI, an eleventh SPI corresponding to the second SPI, and a twelfth SPI corresponding to the third SPI.

16. The electric drive system of claim 15, wherein the master processor device issues commands to the first slave processor device, the second slave processor device, and the third slave processor device using the first SPI and the second SPI.

17. The electric drive system of claim 15, wherein the master processor device and the third slave processor device support inter-processor monitoring using the third SPI and the twelfth SPI.

18. The electric drive system of claim 15, wherein the first slave processor device and the second slave processor device support inter-processor monitoring using the sixth SPI and the ninth SPI.

19. The electric drive system of claim 15, further comprising a single physical circuit board, wherein the master processor device, the first slave processor device, the second slave processor device, and the third slave processor device are all mounted on the single physical circuit board.

20. The electric drive system of claim 13, wherein the master processor device and each of the plurality of slave processor devices is implemented as a distinct integrated circuit chip.
